(19) United States
(12) Patent Application Publication
(10) Pub. No.: US 2008/0074026 A1
(43) Pub. Date: Mar. 27, 2008

(54) FIELD EMISSION ELECTRON SOURCE AND METHOD OF MANUFACTURING THE SAME

(75) Inventors: Tadashi Sakai, Yokohama-shi (JP); Tomio Ono, Yokohama-shi (JP); Naoshi Sakuma, Yokohama-shi (JP); Hiroaki Yoshida, Yokohama-shi (JP); Mariko Suzuki, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/846,929

(22) Filed: Aug. 29, 2007

(30) Foreign Application Priority Data
Sep. 25, 2006 (JP) P2006-258925

(51) Int. Cl. H01J 1/312; H01J 9/02

(52) U.S. Cl. 313/309; 445/49

(57) ABSTRACT

A field emission electron source includes a substrate. A wiring layer is formed on the substrate, and an insulation layer is formed over the wiring layer. In the insulation layer, a plurality of through holes are provided, and conductive via plugs are disposed in the through holes. A diamond layer is formed to cover tops of the insulation layer and the conductive via plugs.

### CROSS-REFERENCE TO RELATED APPLICATIONS

This application is based upon and claims the benefit of priority from the prior Japanese Patent Application No. 2006-258925, filed on Sep. 25, 2006; the entire contents of which are incorporated herein by reference.

### BACKGROUND OF THE INVENTION

1. Field of the Invention

The present invention relates to a field emission electron source emitting electrons from a surface of a solid, and a method of manufacturing the same.

2. Description of the Related Art

A high-power field emission electron source is needed in various applications, but conventionally developed field emission electron sources have various problems to be solved, and it has been especially difficult to realize high-power electron emission in field emission electron sources of a planar type.

One of such field emission electron sources that have conventionally been known is a field emission electron source using a carbon nanotube (CNT) as a cathode (see, for example, “NATURE” Vol. 437 13 Oct., 2005, p. 968). Having a sharp tip shape and a high aspect ratio, this field emission electron source is capable of starting electron emission with a low threshold electric field of about 1 V/μm on average. Moreover, from a macroscopic viewpoint, this field emission electron source can be relatively easily fabricated as a planar electron source having a large area. However, this field emission electron source has a drawback that the structure of its tip portion contributing to the electron emission is delicate and greatly changes with time. In particular, in carbon nanotubes of an open tube type exhibiting a low threshold electric field, it is thought that exposed cross sections of layered graphenes on the order of several atoms, though contributing to the emission, are susceptible to change when their surfaces are heated due to the electron emission and when they are attacked by residual ions, and changes in electron emission characteristic and points have been actually reported.

Another known field emission electron source is one whose electron emission portion is a diamond thin film provided on top of a protruding structure (see, for example, JP-A 9-265892). This field emission electron source has higher surface stability than that using the carbon nanotubes. However, the present technology has not yet realized both sufficiently high-density conduction electrons and a lower work function of the surface, and as a result, at present, the intensity of a threshold electric field is still high. To avoid this, sharpening the diamond film has been attempted and has brought about a certain effect, but by the sharpening, a surface structure has the same susceptibility as that of the aforesaid field emission electron source using the carbon nanotubes, and therefore, the sharpening cannot be said to be a satisfactory solution to the problems including a durability problem. Further, a high resistance of diamond is also a problem in realizing a high-power electron source, that is, its own resistance component may possibly cause heat generation, thermal loss, and so on.

As described above, the conventional arts had problems of difficulty in ensuring durability and difficulty in realizing long-term stable electron emission.

### SUMMARY OF THE INVENTION

According to an aspect of the present invention, there is provided a field emission electron source including: a substrate; a wiring layer provided on the substrate; an insulation layer provided over the wiring layer; a plurality of conductive via plugs passing through the insulation layer; and a diamond thin film layer provided on the insulation layer and the conductive via plugs.

According to another aspect of the present invention, there is provided a method of manufacturing a field emission electron source, including: forming a wiring layer on a substrate; forming an insulation layer over the wiring layer; forming through holes passing through the insulation layer; forming conductive via plugs in the plural through holes; and forming a diamond thin film layer on the insulation layer and the conductive via plugs.

### BRIEF DESCRIPTION OF THE DRAWINGS

FIG. 1 is a view schematically showing the structure of a field emission electron source according to a first embodiment of the present invention.

FIG. 2A to FIG. 2G are views schematically showing a method of manufacturing the field emission electron source shown in FIG. 1.

FIG. 3 is a view schematically showing the structure of a field emission electron source according to a second embodiment of the present invention.

FIG. 4A and FIG. 4B are views schematically showing the structure of a field emission electron source according to a third embodiment of the present invention.

FIG. 5A and FIG. 5B are views schematically showing the structure of a field emission electron source according to a fourth embodiment of the present invention.

FIG. 6 is a view schematically showing the structure of a field emission electron source according to a fifth embodiment of the present invention.

FIG. 7A and FIG. 7B are views schematically showing the structure of a field emission electron source according to a sixth embodiment of the present invention.

### DESCRIPTION OF THE EMBODIMENTS

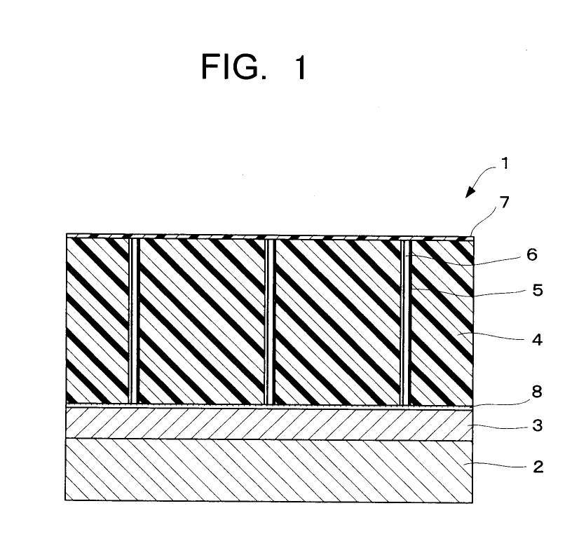

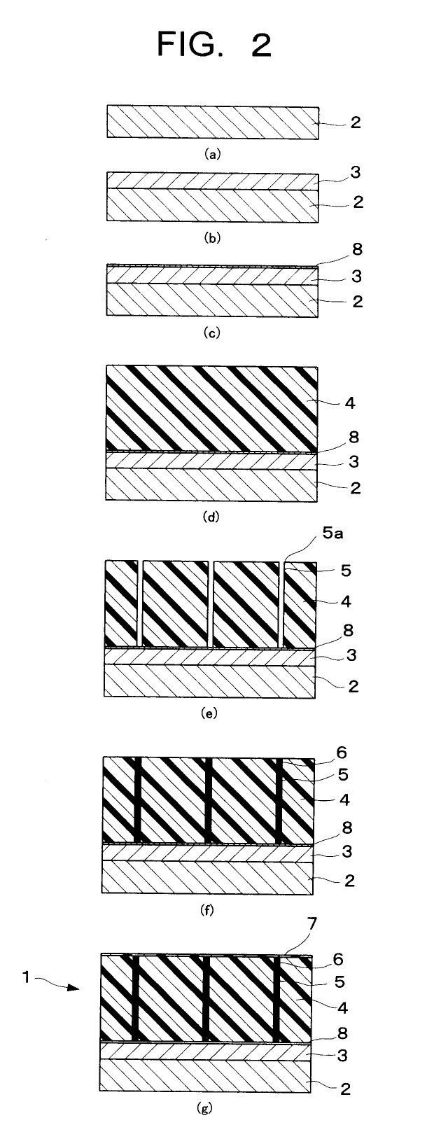

Hereinafter, embodiments of the present invention will be described with reference to the drawings. FIG. 1 schematically shows a cross-sectional structure of an essential part of a field emission electron source in an embodiment, and FIG. 2A to FIG. 2G schematically show manufacturing processes of the field emission electron source shown in FIG. 1.

### First Embodiment

As shown in FIG. 1, a field emission electron source 1 according to a first embodiment includes a substrate 2 made of, for example, silicon, glass, metal, ceramic, or the like. A wiring layer 3 made of a conductor such as copper is formed on the substrate 2, and an insulation layer 4 is formed over the wiring layer 3. A plurality of through holes 5 (via holes) are formed in the insulation layer 4, and conductive via plugs 6 are provided in the through holes 5. In this embodiment, each of the conductive via plugs 6 is made of a carbon nanotube bundle. Further, a diamond layer 7 is formed so as to cover tops of the insulation layer 4 and the conductive via plugs 6. In FIG. 1, reference numeral 8 denotes a catalyst dispersion layer used to form carbon nanotubes.

Hereinafter, a method of manufacturing the field emission electron source 1 shown in FIG. 1 will be described with reference to FIG. 2A to FIG. 2G. The conductive wiring layer 3 is formed on the substrate 2 shown in FIG. 2A by a sputtering method as shown in FIG. 2B. At this time, to make the whole surface serve as a single electron source, the wiring layer 3 may be a conductive layer formed on the whole surface of the substrate 2, but to control a plurality of electron emitting portions individually, the conductive layer is separated and patterned into wiring layers 3a as in a later-described field emission electron source 1d shown in FIG. 6.

Next, as shown in FIG. 2C, the catalyst dispersion layer 8 is formed on a surface of the wiring layer 3 by a colloidal dispersion method or an arc plasma method. The catalyst dispersion layer 8 serves as a catalyst layer used to form the later-described conductive via plugs 6 each made of the carbon nanotube bundle. As a catalyst of the catalyst dispersion layer 8, usable are fine particles of Ni, Co, Fe, or the like, fine particles of any of alloy compositions thereof, and the like. Further, an ultrathin oxide cap layer made of Al₂O₃ or the like may be formed on a surface of this catalyst dispersion layer 8. This oxide cap layer prevents carbon from growing into large particles when the carbon nanotubes are formed.

Next, as shown in FIG. 2D, the insulation layer 4 made of an insulative material is formed over the wiring layer 3 via the catalyst dispersion layer 8. As a material of the insulation layer 4, for example, a silicon oxide is usable, and besides, any of various kinds of low-dielectric-constant materials such as porous oxide, nitride, and the like is usable.

After the insulation layer 4 is formed, the insulation layer 4 is patterned and etched by a photolithography technique or the like using a photoresist, whereby, as shown in FIG. 2E, the plural through holes (via holes) 5 passing through the insulation layer 4 are formed at predetermined positions at predetermined spaced intervals. Desirably, the diameter of each of the via holes 5 is smaller than the thickness of the insulation layer 4. That is, each of the via holes 5 desirably has a cross sectional shape whose height is longer than diameter. If a ratio of the former to the latter is an aspect ratio, the via hole 5 desirably has a cross-sectional shape with the aspect ratio of 1 or more. With such a shape, a higher effect of electric field concentration can be expected. As concrete dimensions, the diameter of the via holes 5 is, for example, about 0.1 μm, and the thickness of the insulation layer 4 is, for example, about 1 μm.

Next, as shown in FIG. 2F, the conductive via plugs 6 are formed in the via holes 5. As each of the conductive via plugs 6, the carbon nanotube bundle is used in this embodiment. Various methods have been known as a method of forming the carbon nanotube bundle, and any method capable of forming the carbon nanotube bundle may be used. As an example, in a case where microwave plasma CVD is used, by heating with a heater or the like in mixed gas of methane and at least one of hydrogen, argon, and helium, a carbon plasma species discharged and excited by a microwave acts on the catalyst dispersion layer 8 on bottom portions of the via holes 5, so that the carbon nanotube bundles grow in the via holes 5. Other than the microwave plasma CVD, any of major CVD methods is usable such as hot filament CVD, surface wave plasma CVD, ECR plasma CVD, RF plasma CVD, and DC plasma CVD.

By the above-described method, the carbon nanotube bundles are made to overgrow up to a position higher than upper ends 5a of opening portions of the via holes 5, and thereafter, as shown in FIG. 2F, protruding portions are removed for planarization by a method such as CMP or RIE. Next, as shown in FIG. 2G, the diamond layer 7 is formed so as to cover surfaces of the conductive via plugs 6 and the insulation layer 4. The diamond layer 7 is preferably made of nanodiamond. The nanodiamond mentioned here has smaller particle size than classical polycrystalline diamond and includes a diamond carbon cluster with a particle size of 1000 nm or less, preferably, 200 nm or less. Further, as for a component of the nanodiamond mentioned here, nanodiamond whose component is pure diamond is usable, and besides, usable is nanodiamond doped with impurities, that is, doped with an n-type material such as phosphorus, nitrogen, or sulfur, or a p-type material such as boron. The diamond layer 7 made of nanodiamond may be formed by any method, and for example, can be formed by a plasma CVD method. Alternatively, it may be formed by applying diamond followed by sintering for fixation. The diamond layer 7 has a thickness of, for example, 0.1 μm or less. By the use of the nanodiamond to form the diamond layer 7 as in this embodiment, a diamond surface can be a thin layer, which would not be possible by the use of a polycrystalline diamond, and consequently, it is possible to realize electron emission from the surface with a minimum loss inside the diamond whose resistance is higher than in the nanotube.

To form the nanodiamond by the plasma CVD, for example, the temperature is increased to about 200° C. to about 600° C. under the atmosphere of mixed gas of methane and hydrogen, and plasma having higher power density than plasma for causing the growth of the carbon nanotube is generated to cause reaction. To retard the growth of crystal grains of the nanodiamond, cooling from a rear surface of the substrate 2 is also effective. Further, modifying the surface with adamantane, nanodiamond colloid, or the like prior to the crystal growth can improve nucleation density of the crystal growth. In this manner, the diamond layer 7 made of the nanodiamond is formed uniformly on the carbon nanotubes (conductive via plugs 6) and the surrounding insulation layer 4, whereby the field emission electron source 1 of this embodiment is completed.

With the above-described structure, according to the embodiment of the present invention, since the plural conductive via plugs 6 with a small diameter are provided in the insulation layer 4 at spaced intervals, it is possible to cause the electric field concentration onto each of the conductive via plugs 6 under a controlled state. Further, since the diamond layer 7 is provided on the surfaces of the conductive via plugs 6 with this structure, an emission surface can have a flat and firm structure, resulting in improved durability. Further, though a wide band gap of the diamond layer 7 makes the electron injection difficult, it is possible to easily cause charge injection owing to the effect of the electric field concentration realized by the structure where the conduction layer in contact with the diamond layer 7 from the rear surface is formed as the via plugs with the small diameter, and owing to an increase in electron speed realized by ballistic conduction.

That is, according to the field emission electron source of this embodiment, the susceptibility of a sharp tip structure which has been a problem in conventional field emission electron sources of a sharp-tip type is greatly reduced. In an actual apparatus using the electron source, for example, in an X-ray tube, an electron beam generator, and the like, the problem of surface attack by residual gas ions cannot be completely avoided, but since the conductive via plugs 6 are covered by the diamond layer 7, surface change and durability deterioration can be greatly reduced. Specifically, in general, the sharp cross section and surface structure of a carbon nanotube, a carbon nanowall, or the like are easily changed in shape by the ion attack, but on the other hand, the surface of the aforesaid diamond layer 7 is far more stable than the sharp portions and has an effect that its damage, if any, does not easily lead to a great characteristic change unlike the point structural change of the sharp portions.

For the above reasons, the field emission electron source of this embodiment is capable of realizing high-power electron emission, has excellent durability, and is capable of realizing long-term stable electron emission.

### Second Embodiment

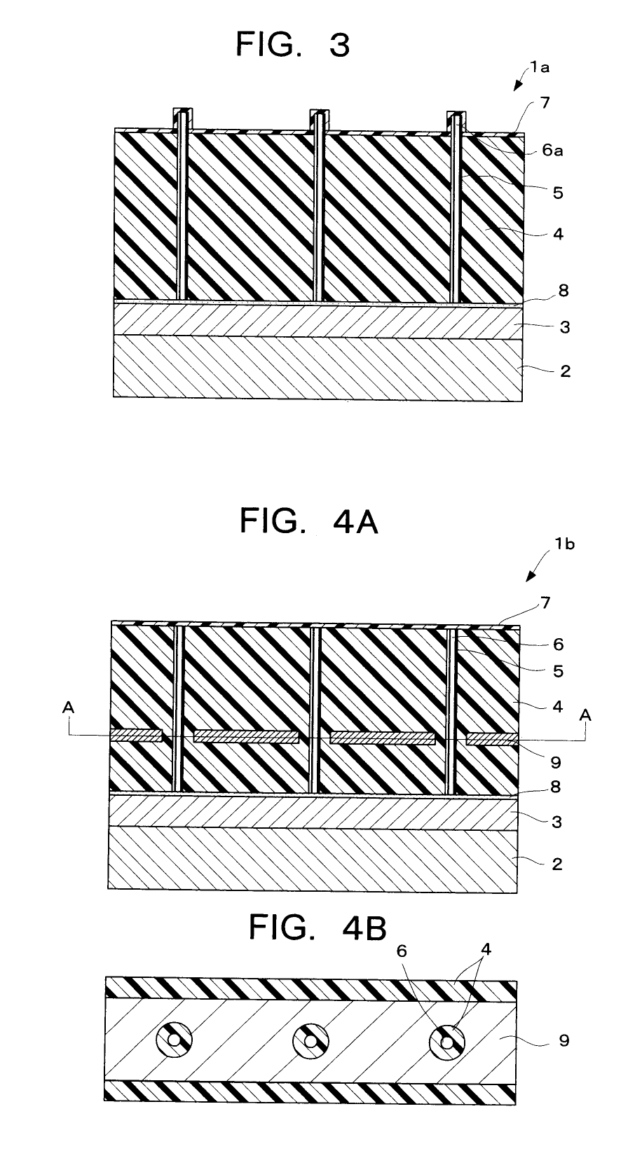

FIG. 3 shows across-sectional structure of a field emission electron source according to a second embodiment. In a field emission electron source 1a according to the second embodiment shown in FIG. 3, the same reference numerals and symbols as those in the above-described first embodiment are used to designate the same members as those of the first embodiment, and detailed description thereof, for which the above description will be referred to, will be omitted here.

The field emission electron source 1a according to the second embodiment is a modification example of the field emission electron source 1 according to the above-described first embodiment, and in this embodiment, conductive via plugs 6a protruding upward from the surface of the insulation layer 4 are formed in place of the conductive via plugs 6, and the diamond layer 7 is formed on the protruding conductive via plugs 6a to cover them. To form such a structure, carbon nanotube bundles are grown to protrude upward from the surface of the insulation layer 4 at the time of the growth of the carbon nanotube bundles in the via holes 5.

Having the above-described structure, the field emission electron source according to this embodiment has not only the effects of the above-described first embodiment but also an effect that an electric field concentrates more effectively on the protruding portions owing to the aforesaid protruding structure of the surface, which makes it easy to cause electron emission.

### Third Embodiment

FIG. 4A shows a cross-sectional structure of a field emission electron source according to a third embodiment, and FIG. 4B shows a cross section taken along the A-A line in FIG. 4A. In a field emission electron source 1b according to the third embodiment shown in FIG. 4A and FIG. 4B, the same reference numerals and symbols as those in the above-described first embodiment are used to designate the same members as those of the first embodiment, and detailed description thereof, for which the above description will be referred to, will be omitted.

A field emission electron source 1b according to the third embodiment is a modification example of the field emission electron source 1 according to the above-described first embodiment, and includes a gate electrode 9 having a function of electrically controlling field emission. The gate electrode 9 is formed in the aforesaid insulation layer 4 to be adjacent via the insulation layer 4 to the conductive via plugs 6 made of the carbon nanotube bundles. As shown in FIG. 4B, the gate electrode 9 is formed to surround the conductive via plugs 6. An electric field can be applied via the gate electrode 9 to the conductive via plugs 6 by a not-shown voltage applier provided outside the field emission electron source 1b.

For example, applying positive potential to the gate electrode 9 and applying negative potential to the wiring layer 3 result in the reduce of field enhancement of top of via plug 6. As a result, the emission current decreases. It is also possible to eliminate the conduction in the conductive via plugs 6 to stop the emission current by further applying a stronger voltage to the gate electrode 9. Further, if the inverse potentials are applied to the gate electrode 9 and the wiring layer 3, electrons are promoted to emit more easily because of field enhancement of the top.

Having the above-described structure, the field emission electron source according to this embodiment not only has the effects of the above-described first embodiment but also can have a function of controlling electron emission.

### Fourth Embodiment

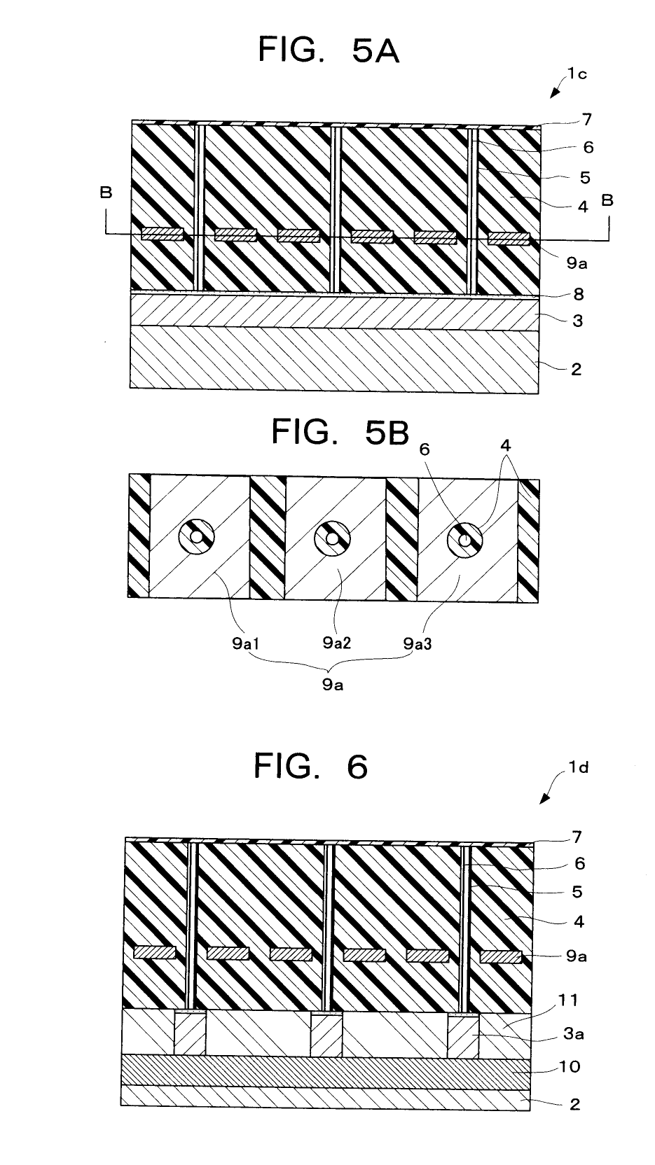

FIG. 5A shows a cross-sectional structure of a field emission electron source according to a fourth embodiment, and FIG. 5B shows a cross section taken along the B-B line in FIG. 5A. In a field emission electron source 1c according to the fourth embodiment shown in FIG. 5A and FIG. 5B, the same reference numerals and symbols as those in the above-described first embodiment are used to designate the same members as those of the first embodiment, and detailed description thereof, for which the above description will be referred to, will be omitted.

The field emission electron source 1c according to the fourth embodiment is a modification example of the field emission electron source 1 according to the above-described first embodiment, and includes a gate electrode 9a composed of a plurality of gate electrodes 9a1, 9a2, 9a3, . . . each independently provided for each of the conductive via plugs 6, and for each of the gate electrodes 9a1, 9a2, 9a3, . . . , a not-shown voltage applier is provided outside the field emission electron source 1c, which makes it possible to apply an electric field independently to each of the conductive via plugs 6.

The above-described structure enables independent emission control for each of the conductive via plugs 6 or electron emission control for part thereof. Incidentally, burying the gate electrodes 9a1, 9a2, 9a3, . . . in the insulation layer 4 as shown in FIG. 5A and FIG. 5B makes it possible to perform an emission control operation without losing the effect of electric field concentration on the conductive via plugs 6 positioned thereabove. The gate electrodes 9a1, 9a2, 9a3, . . . may be formed on an upper surface or a lower surface of the surface diamond layer 7, other than in the insulation layer 4.

### Fifth Embodiment

FIG. 6 shows a cross-sectional structure of a field emission electron source according to a fifth embodiment. In a field emission electron source 1d according to the fifth embodiment shown in FIG. 6, the same reference numerals and symbols as those in the above-described first embodiment are used to designate the same members as those of the first embodiment, and detailed description thereof, for which the above description will be referred to, will be omitted.

The field emission electron source 1d according to the fifth embodiment is a modification example of the field emission electron source 1 according to the above-described first embodiment, and includes: separate wiring layers 3a which are formed by patterning so as to correspond to the respective conductive via plugs 6; a control circuit layer 10 provided under the wiring layers 3a; and the plural gate electrodes 9a1, 9a2, 9a3, . . . described in the fourth embodiment. By this structure, electron emission may be individually controlled or monitored. Reference numeral 11 in FIG. 6 is an interlayer insulation film formed between the wiring layers 3a.

### Sixth Embodiment

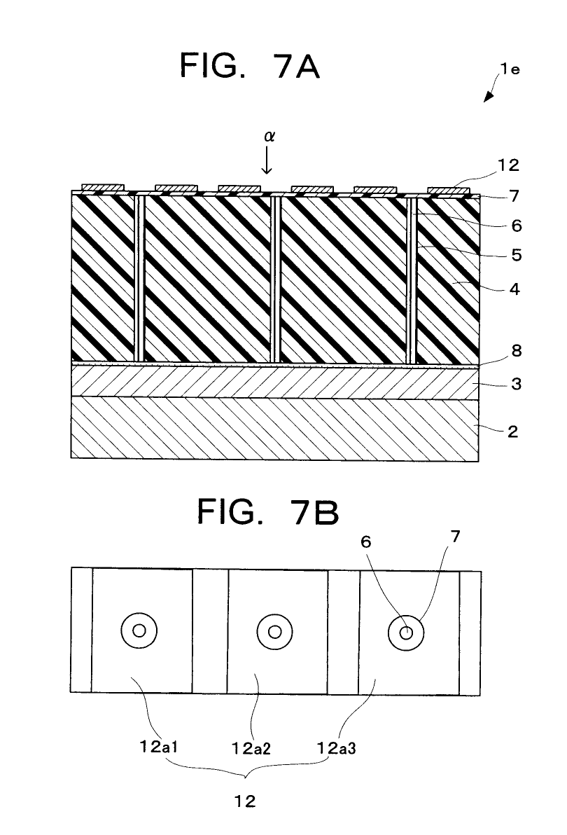

FIG. 7A shows a cross-sectional structure of a field emission electron source according to a sixth embodiment, and FIG. 7B is a plan view seen from the a direction in FIG. 7A. In a field emission electron source 1e according to the sixth embodiment shown in FIG. 7A and FIG. 7B, the same reference numerals and symbols as those in the above-described first embodiment are used to designate the same members as those of the first embodiment, and detailed description thereof, for which the above description will be referred to, will be omitted.

The field emission electron source 1e according to the sixth embodiment is a modification example of the field emission electron source 1 according to the above-described first embodiment, and includes a focus electrode 12 formed on an upper surface of the diamond layer 7 and composed of a plurality of focus electrodes 12a1, 12a2, 12a3, . . . each provided independently for each of the conductive via plugs 6. A not-shown voltage applier is provided outside the field emission electron source 1e for each of the focus electrodes 12a1, 12a2, 12a3, . . . , which makes it possible to apply an electric field independently to each of the conductive via plugs 6. This structure enables gate action, polarization, shaping, and so on of beams of emitted electrons. Further, the above-described structure enables independent emission control for each of the conductive via plugs 6 or electron emission control for part thereof.

The present invention is not limited to the contents described in the above embodiments, and the structure, materials, arrangement of the members, and so on may be appropriately changed within a range not departing from the spirit of the present invention. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A field emission electron source comprising:
a substrate;
a wiring layer provided on the substrate;
an insulation layer provided over the wiring layer;
a plurality of conductive via plugs passing through the insulation layer; and
a diamond thin film layer provided on the insulation layer and the conductive via plugs.

2. The electron source according to claim 1,
wherein each of the conductive via plugs is made of a carbon nanotube exhibiting a characteristic of ballistic conduction.

3. The electron source according to claim 2, further comprising
a catalyst dispersion layer provided between the wiring layer and the insulation layer and used to form the carbon nanotubes.

4. The electron source according to claim 1,
wherein the diamond thin film layer has a characteristic of electron affinity of 0 or less

5. The electron source according to claim 1,
wherein end portions of the conductive via plugs protrude from a surface of the insulation layer.

6. The electron source according to claim 1, further comprising
an electrode for electric field application formed in the insulation layer to control conduction in the conductive via plugs.

7. The electron source according to claim 6,
wherein the electrode for electric field application is formed independently for each of the conductive via plugs.

8. The electron source according to claim 7,
wherein the wiring layer is formed as separate wiring layers corresponding to the conductive via plugs respectively, and a control circuit layer is provided between the wiring layers and the substrate.

9. The electron source according to claim 1, further comprising
an electrode for electric field application provided on the diamond thin film layer to control electrons emitted from the conductive via plugs.

10. The electron source according to claim 3,
wherein the diamond thin film layer has a characteristic of electron affinity of 0 or less.

11. The electron source according to claim 3,
wherein end portions of the conductive via plugs protrude from a surface of the insulation layer.

12. The electron source according to claim 3, further comprising
an electrode for electric field application formed in the insulation layer to control conduction in the conductive via plugs.

13. The electron source according to claim 12,
wherein the electrode for electric field application is formed individually for each of the conductive via plugs.

14. The electron source according to claim 13,
wherein the wiring layer is formed as separate wiring layers corresponding to the conductive via plugs respectively, and a control circuit layer is formed between the wiring layers and the substrate.

15. The electron source according to claim 3, further comprising
an electrode for electric field application provided on the diamond thin film layer to control electrons emitted from the conductive via plugs.

16. A method of manufacturing a field emission electron source, comprising:
forming a wiring layer on a substrate;
forming an insulation layer over the wiring layer;
forming through holes passing through the insulation layer;
forming conductive via plugs in the plural through holes; and
forming a diamond thin film layer on the insulation layer and the conductive via plugs.

17. The method according to claim 16, further comprising
forming a catalyst dispersion layer between the forming the wiring layer and the forming the insulation layer,
wherein in the forming the conductive via plugs, carbon nanotubes exhibiting a characteristic of ballistic conduction are formed on the catalyst dispersion layer.
